(19) United States
(12) Patent Application Publication
(10) Pub. No.: US 2007/0221273 A1
(43) Pub. Date: Sep. 27, 2007

(54) Valve for beverage dispenser

(76) Inventor: Jerry L. Landers, Memphis, IN (US)

Correspondence Address: BRINKS HOFER GILSON & LIONE, P.O. BOX 10395, CHICAGO, IL, 60610, US

(21) Appl. No.: 11/387,113

(22) Filed: Mar. 22, 2006

(51) Int. Cl. F16K 31/36

(52) U.S. Cl. 137/510

(57) ABSTRACT

A valve particularly useful for regulating the flow of water in a beverage dispenser includes a housing having an inlet and an outlet and a water flow path there between; a diaphragm and a sealing ring against which the diaphragm may seal to close the water flow path through the valve, the area confined by the sealing ring being subject to pressure of water entering the housing inlet; a spring acting against the diaphragm to urge it against the sealing ring in opposition to force generated by pressure of water in the inlet; an inlet channel upstream of the sealing ring; and a throttling pin positioned in the inlet channel and responsive to movement of the diaphragm to partially block the inlet channel when the pressure in the inlet forces the diaphragm to open against the spring force, the movement of the diaphragm thus regulating the flow of water through the housing. The preferred valve is improved in several respects. The flow path through the valve is configured to minimize the breakout of carbonation when the valve is used for carbonated water. The sealing ring lies in a plane, and both the inlet and outlet are on the same side of the plane, with the outlet positioned so as to be at an angle of approximately 90° compared to the inlet. A second valve of similar design but smaller, used to control the flow of syrup, can be nested so that the spring of the syrup valve is nested side the spring used to control the water valve.

### RELATED APPLICATION

The present application claims the benefit under 35 U.S.C. § 119(e) of Provisional U.S. Patent Application Serial No. (unknown at present, but believed to be titled “CONSTANT FLOW VALVE”, and to have been filed Mar. 22, 2005, erroneously in the name of John R. Newton as the sole inventor); which is hereby incorporated by reference in its entirety.

### BACKGROUND OF THE INVENTION

This invention relates generally to fluid valves, and is concerned in particular with an improved valve that can be used in a beverage dispenser.

A regulating valve that is normally closed, that is opened by a variable fluid pressure above a selected threshold level, and that, when open, strives to deliver the fluid at a constant pressure and flow rate, is known, as disclosed for example in U.S. Pat. No. 6,026,850 and No. 6,209,578, hereby incorporated herein in their entirety by reference. While these known valves operate in a satisfactory manner, for some uses, their design has proven to be overly complex, expensive, and difficult to incorporate in restricted spaces within fluid dispensing equipment, e.g., soft drink dispensers. For one thing, the valves are not designed with the concept of being used with carbonated water. Second, for required flow rates, the size of the valve is not compact enough to be included along side a syrup delivery valve inside of the framework allowed for beverage dispensing valve assemblies.

### BRIEF DESCRIPTION OF THE DRAWINGS

FIG. 1 is a sectional view through a regulating valve in accordance with the present invention, the valve being shown in its open condition.

FIG. 2 is a sectional view showing an assembly of two valves in accordance with the present invention, both valves again being shown in the open condition.

FIG. 3 is a perspective view of the inside of a first cap, used to make a valve with a flow path that is smoothed out to minimize breakout of carbonation when the valve is used for carbonated water.

FIG. 4 is a perspective view of the inside of a second cap, used to make a valve where the inlet and outlet are both on the same side of the diaphragm used in the valve.

### DETAILED DESCRIPTION OF PREFERRED EMBODIMENTS

Valves of the present invention are useful on a variety of beverage dispensers, such as those disclosed in U.S. Pat. No. 4,641,763, No. 5,397,032, No. 6,761,036 and No. 6,698,621, each of which are hereby incorporated by reference in their entirety. To be useable in a beverage dispenser, a water valve must be able to operate with fairly high inlet pressures. Currently valves are expected to be operable over a range of 40-100 psi. Many beverage dispensers have an inlet water pressure to the valve of about 75 psi.

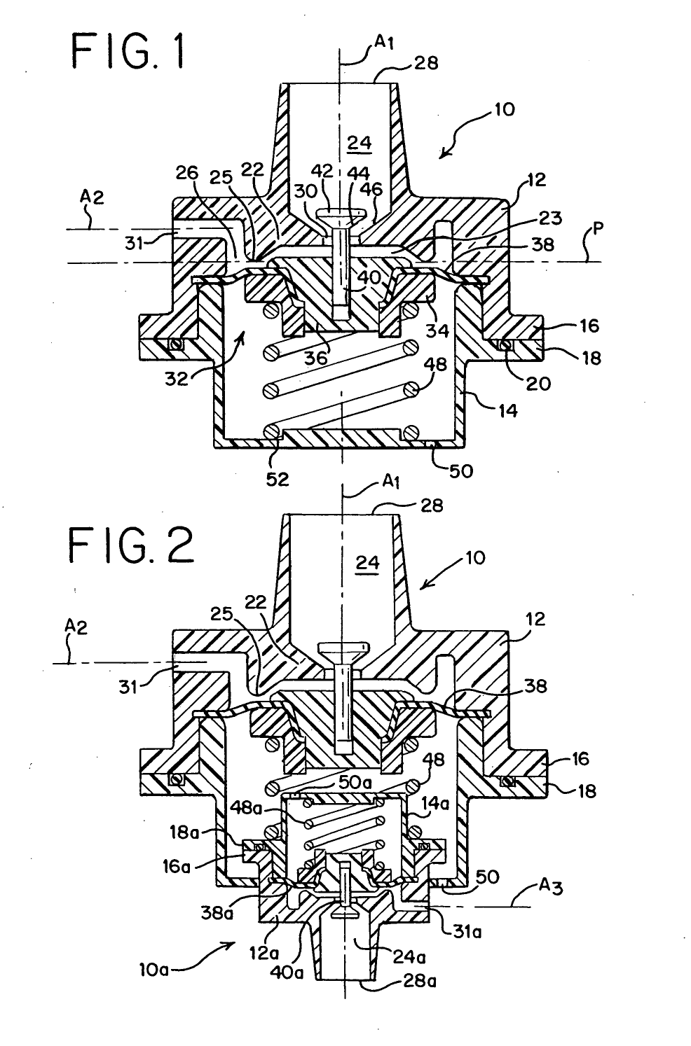

With reference initially to FIG. 1, a regulating valve in accordance with the present invention is generally depicted at 10. The valve includes an outer housing having a cap 12 joined to a cup-shaped base 14 at mating exterior flanges 16, 18, with an O-ring seal 20 interposed therebetween.

The housing is internally subdivided by a barrier wall 22 into an input section 24 and an output section 26. An inlet 28 is adapted to be connected to a fluid supply (not shown) having a pressure that can vary from below to above a threshold level. The inlet 28 and a central port or inlet channel 30 in the barrier wall 22 are aligned along a central first axis A₁ of the valve. An outlet port 31 is aligned on a second axis A₂ transverse to the first axis A₁. The inlet 28 and outlet 31 are generally cylindrical in nature.

A modulating assembly 32 cooperates with the barrier wall 22 to define a chamber 23 segregated from the remainder of outlet section 26. The modulating assembly serves to prevent fluid flow through the valve when the fluid pressure at the inlet 28 is below the threshold pressure. When the fluid pressure at the inlet exceeds the threshold pressure, the modulating assembly serves to accommodate fluid flow from the inlet section 24 through port 30 into chamber 23 at a constant pressure and flow rate, and from there through outlet port 31. Either the outlet port 31 or a downstream orifice or flow restrictor (not shown) serves to develop a back pressure in chamber 23.

The modulating assembly 32 includes a piston comprised of a hollow shell 34 and a central plug 36. The piston is supported for movement in opposite directions along axis A₁, by a flexible annular diaphragm 38. The inner periphery of the diaphragm is captured between the shell 34 and plug 36, and the outer periphery of the diaphragm is similarly captured between the cap 12 and base 14.

A stem 40 on the piston plug 36 projects through the port 30 into the inlet section 24. An enlarged head 42 on the stem acts as a throttling pin, and has a tapered underside 44 that coacts with a tapered surface 46 of the barrier wall to modulate the size of the flow path through the port 30 as an inverse function of the varying fluid pressure in the input section, with the result being to deliver fluid to the output section at a constant pressure and flow rate.

A compression spring 48 is captured between an underside surface of shell 34 and the bottom wall 52 of the housing base 14. The spring urges the modulating assembly 32 towards the sealing ring 25 formed on barrier wall 22. The area confined by the sealing ring 25 is subject to pressure of water entering the housing inlet 28. When the fluid pressure at the inlet 28 is below the threshold pressure, spring 48 is sufficient to hold the diaphragm 38 against the sealing ring 25, thus preventing fluid flow through the port 30. For water valves used in a beverage dispenser, the spring will typically be sufficient to keep the valve closed until a threshold pressure is achieved, that threshold pressure being 40 psi or greater, and more typically 55 psi.

As the fluid pressure exceeds the threshold pressure, the resilient closure force of spring 48 is overcome, allowing the piston assembly to move away from the barrier wall 22 and sealing ring 25, and allowing the modulating function of the coacting tapered surfaces 44, 46 to commence. An opening 50 in the bottom wall 52 serves to vent the volume beneath diaphragm 38 to the surrounding atmosphere.

Sealing ring 25 is round in shape, and lies in plane P. In the embodiment shown in FIG. 1, both the inlet 28 and outlet 31 are located on the same side of plane P. Compared to a valve with the inlet and outlet on different sides of plane P (such as the valves shown in U.S. Pat. Nos. 6,026,850 and 6,209,578, in which the inlet and outlet ports are axially aligned), this allows the valve to be configured in a more compact manner, and it also makes the flow path through the valve much shorter and less tortuous, thus minimizing breakout of carbonation. In this improved embodiment, the inlet and the outlet are positioned so that the outlet is at an angle of approximately 90° compared to the inlet, which also makes the valve easier to use in a beverage dispenser.

FIG. 2 shows a combined water and syrup valve assembly for use in dispensing two different fluids to a remote mixing chamber in a beverage dispenser. In this assembly, the valve 10 is used to control the flow of carbonated water. A second valve, 10a, is used to control the flow of a flavored syrup. The second valve 10a is inverted and telescopically assembled into the base 14 of the valve 10. Valve 10a is substantially identical (although of smaller size) to valve 10. The components of valve 10a have been identified by the same reference numerals, with the addition of an “a” modifier. For example, the water diaphragm is labeled as 38, and the syrup diaphragm is labeled as 38a.

The two valves 10, 10a are combined in an axially compact assembly, with the base 14a of valve 10a serving as a guide post for the compression spring 48 of valve 10, with the coil spring 48a partially physically nested within spring 48. Of course when coil springs are used, the external diameter of the coil spring 48a used on the syrup valve is smaller in diameter than the internal diameter of the coil spring 48 used on the water valve. The valve outlet 31a is aligned on a third axis A₂, which is also transverse to the common central axis A₁ of both valves 10, 10a.

While the embodiment of valve 10a depicted has all of the features of valve 10, including the throttling pin 40a, in some embodiments it is possible that a syrup valve of simpler construction may be used instead.

The valve cap 112 shown in FIG. 3 is configured to be used with a valve like valve 10 shown in U.S. Pat. No. 6,209,578 in which the flow path through the valve is around the diaphragm and through an outlet disposed on the opposite side of the plane of the sealing ring against which the diaphragm shuts off compared to the inlet. In this type of valve, the water has to go around several bends. In addition, in one prior art embodiment of this type of valve, there are about a dozen passageways past the diaphragm, and the passageways are all made of channels with sharp corners. The improved cap 112, on the other hand, is designed so that the flow path through the valve is smoothed out and otherwise configured to minimize the breakout of carbonation from carbonated water that flows through the valve. The inlet 128 is shown without the throttling pin and diaphragm in place. However, sealing ring 125 against which the diaphragm seats is shown. Just outside the sealing ring is an annular passageway 127 that feeds four flow channels 129. As seen in FIG. 3, the channels 129 are made with rounded corners as a way of minimizing carbonation breakout. The rounded corners include a very large radius on the outside surface, where the water flow is directed downwardly after it enters from the annular passageway 127. In addition, the exterior corners 131 and 133 of the channels are each rounded.

In addition to the smoothed and rounded surfaces, the flow path through the valve made with the cap 112 is also configured to minimize carbonation breakout in other ways. The internal volume of the valve is balanced with the flow rate through the valve and back pressure so that the volume of the flow path is minimized as a way of minimizing carbonation breakout. This may be accomplished by shrinking (using modified prototypes of the valve for testing) the components of the internal flow path, such as the width of the annular passageway 127, until the flow rate through the valve is just reduced below the desired rating. The channels are then widened slightly. The valve is thus balanced so that there is not extra volume in the valve that would allow carbonation to breakout.

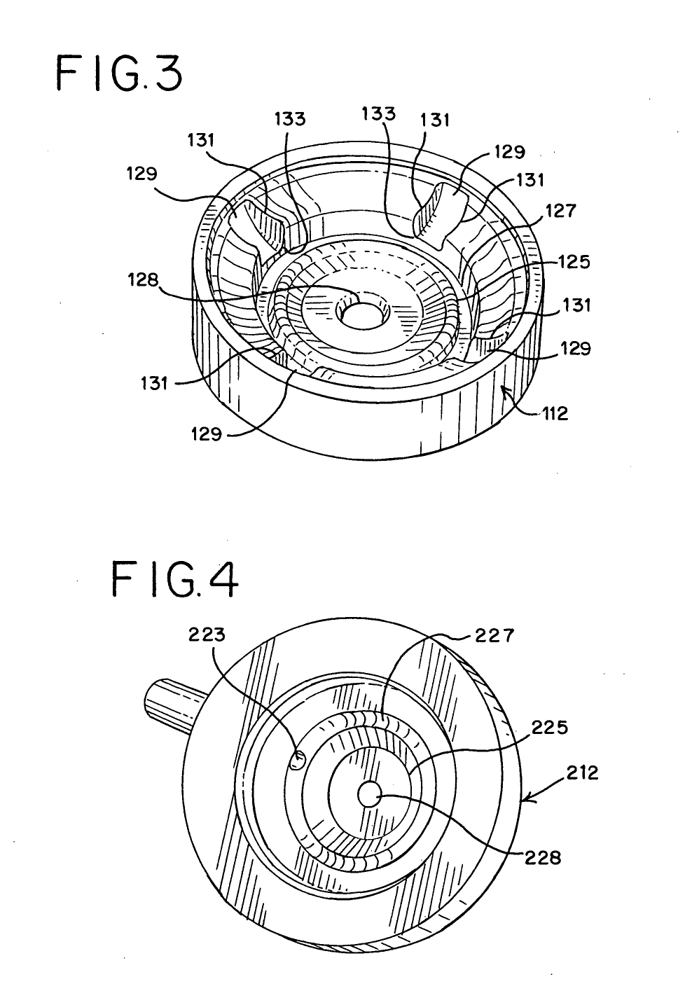

Another way to configure the flow path through the valve to minimize breakout of carbonation is reflected in the design of cap 212, shown in FIG. 4. In this design, the flow path has an outlet 223 adjacent the sealing ring 225 as a way of minimizing carbonation breakout. In this embodiment, which will look much like FIG. 1 in cross section, the flow path does not have to go down around the diaphragm. Instead the annular passageway 227 feeds directly into outlet 223. The reduced length of the flow path thus makes it inherently less torturous, and minimizes carbonation breakout. Of course the surfaces and corners in the flow path should have rounded edges and be made smooth, as shown in FIG. 4.

In addition to the fact that the outlet is adjacent the sealing ring 225, this also locates the outlet on the same side of the plane that contains sealing ring 225 as the inlet 228. In the cap 212, the outlet is at approximately 90° to the inlet. Of course it would also be possible to take the outlet though the top of the cap, from an outlet formed in the top, instead of the side, of the annular passageway 227. Whether the valve has an outlet at 90° from the inlet or parallel to the inlet is thus a matter of design freedom that can be used to the advantage of other design considerations for the valve.

The preferred embodiments of the valve are thus an improvement over other constant flow valves known in the art, and make the valves particularly suitable for beverage dispensers, especially for carbonated water with inlet water pressures of 40 psi and greater.

It should be appreciated that the apparatus of the present invention is capable of being incorporated in the form of a variety of embodiments, only a few of which have been illustrated and described above. The invention may be embodied in other forms without departing from its spirit or essential characteristics. For example, the relative position of the inlet channel and diaphragm could be reversed as disclosed in U.S. Pat. No. 3,948,285, such that the inlet pressure acted against the area outside of the sealing ring, and the throttling pin and channel were downstream of the diaphragm. The described embodiments are to be considered in all respects only as illustrative and not restrictive, and the scope of the invention, therefore, is indicated by the appended claims rather than by the foregoing description. All changes that come within the meaning and range of equivalency of the claims are to be embraced within their scope.

1. A combined water and syrup valve assembly for use in a beverage dispenser comprising:
a) a water valve comprising:
i) a housing having a water inlet and a water outlet and a water flow path there between;
ii) a water diaphragm and a first sealing ring against which the water diaphragm may seal to close the water flow path through the valve; the area confined by the sealing ring being subject to pressure of water entering the housing inlet;
iii) a first spring acting against the water diaphragm to urge it against the first sealing ring in opposition to force generated by said pressure of water in the inlet;
iv) an inlet channel upstream of the sealing ring; and
v) a throttling pin positioned in said inlet channel and responsive to movement of the water diaphragm to partially block the inlet channel when the pressure in the inlet forces the water diaphragm to open against the spring force, the movement of the diaphragm thus regulating the flow of water through the housing; and
b) a syrup valve comprising:
i) a housing having a syrup inlet and a syrup outlet and a syrup flow path there between;
ii) a syrup diaphragm and a second sealing ring against which the syrup diaphragm may seal to close the syrup flow path through the valve; and
iii) a second spring acting against the syrup diaphragm to urge it against the second sealing ring in opposition to force generated by pressure of syrup in the syrup inlet; the second spring being at least partially physically nested within said first spring.

2. The combined water and syrup valve assembly of claim 1 wherein the first and second springs are both coil springs having an internal diameter and an external diameter, and the external diameter of the second spring is less than the internal diameter of the first spring.

3. The combined water and syrup valve assembly of claim 1 wherein the first and second sealing rings are each round in shape.

4. The combined water and syrup valve assembly of claim 1 wherein the water valve is configured for use with carbonated water.

5. The combined water and syrup valve assembly of claim 4 wherein the flow path through the water valve is configured to minimize the breakout of carbonation from the carbonated water.

6. The combined water and syrup valve assembly of claim 1 wherein the water sealing ring lies in a plane, and both the water inlet and water outlet are located on the same side of said plane.

7. The combined water and syrup valve assembly of claim 1 wherein the water inlet and the water outlet are positioned such that the outlet is at an angle of approximately 90° compared to the inlet.

8. A beverage dispenser comprising the combined water and syrup valve assembly of claim 1.

9. A carbonated water valve for use in a beverage dispenser comprising:
a) a housing having an inlet and an outlet and a carbonated water flow path there between;
b) a diaphragm and a sealing ring against which the diaphragm may seal to close the water flow path through the valve, the area confined by the sealing ring being subject to pressure of carbonated water entering the housing inlet;
c) a spring acting against the diaphragm to urge it against the sealing ring in opposition to force generated by pressure of carbonated water in the inlet;
d) an inlet channel upstream of the sealing ring; and
e) a throttling pin positioned in said inlet channel and responsive to movement of the diaphragm to partially block the inlet channel when the pressure in the inlet forces the diaphragm to open against the spring force, the movement of the diaphragm thus regulating the flow of water through the housing;
f) the flow path through the valve being configured to minimize the breakout of carbonation from the carbonated water.

10. The carbonated water valve of claim 9 wherein the flow path has channels and the channels are made with rounded corners as a way of minimizing carbonation breakout.

11. The carbonated water valve of claim 10 wherein the flow path includes four flow channels for directing flow around the diaphragm.

12. The carbonated water valve of claim 9 wherein the internal volume of the valve is balanced with the flow rate through the valve and back pressure so that the volume of the flow path is minimized as a way of minimizing carbonation breakout.

13. The carbonated water valve of claim 9 wherein the flow path has an outlet adjacent the sealing ring as a way of minimizing carbonation breakout.

14. The carbonated water valve of claim 13 wherein the sealing ring lies in a plane, and both the inlet and outlet are located on the same side of said plane.

15. A beverage dispenser comprising the carbonated water valve of claim 9.

16. A water valve for use in a beverage dispenser comprising:
a) a housing having an inlet and an outlet and a water flow path there between;
b) a diaphragm and a sealing ring against which the diaphragm may seal to close the water flow path through the valve, the area confined by the sealing ring being subject to pressure of water entering the housing inlet;
c) a spring acting against the diaphragm to urge it against the sealing ring in opposition to force generated by pressure of water in the inlet, the spring being sufficient to keep the valve closed until a threshold pressure is achieved, said threshold pressure being 40 psi or greater;
d) an inlet channel upstream of the sealing ring; and
e) a throttling pin positioned in said inlet channel and responsive to movement of the diaphragm to partially block the inlet channel when the pressure in the inlet forces the diaphragm to open against the spring force, the movement of the diaphragm thus regulating the flow of water through the housing;
f) wherein the sealing ring lies in a plane, and both the inlet and outlet are located on the same side of said plane.

17. The water valve of claim 16 wherein the inlet and outlet are both cylindrical in nature and have an axis, and the axis of the inlet is at approximately 90° to the axis of the outlet.

18. The water valve of claim 16 wherein the flow path through the valve is configured to minimize the breakout of carbonation when carbonated water is dispensed through the valve.

19. A beverage dispenser comprising the water valve of claim 16.

20. In an improved water valve comprising:
a) a housing having an inlet and an outlet and a water flow path there between;
b) a diaphragm and a sealing ring against which the diaphragm may seal to close the water flow path through the valve, the area confined by the sealing ring being subject to pressure of water entering the housing inlet;
c) a spring acting against the diaphragm to urge it against the sealing ring in opposition to force generated by pressure of water in the inlet;
d) an inlet channel upstream of the sealing ring; and
e) a throttling pin positioned in said inlet channel and responsive to movement of the diaphragm to partially block the inlet channel when the pressure in the inlet forces the diaphragm to open against the spring force, the movement of the diaphragm thus regulating the flow of water through the housing;
f) the improvement comprising positioning the inlet and the outlet so that the outlet is at an angle of approximately 90° compared to the inlet.
